(19) United States
(12) Patent Application Publication
(10) Pub. No.: US 2012/0192111 A1
(43) Pub. Date: Jul. 26, 2012

(54) ELECTONIC DEVICE AND METHOD FOR VARYING ICON SIZES OF MENU ICONS

(75) Inventors: CHIH-PU HSU, Tu-Cheng (TW); CHI LIU-HSU, Tu-Cheng (TW)

(73) Assignee: CHI MEI COMMUNICATION SYSTEMS, INC., Tu-Cheng (TW)

(21) Appl. No.: 13/172,846

(22) Filed: Jun. 30, 2011

(30) Foreign Application Priority Data
Jan. 20, 2011 (TW) 100102045

(51) Int. Cl. G06F 3/048

(52) U.S. Cl. 715/821

(57) ABSTRACT

An electronic device and a method execute variable size function of menu icons in a user interface. The electronic device can change the variable menu icon size by an execution status of the menu icons corresponding to an application in the memory during a time period. During the time period, if one of the menu icons is not executed, the one of menu icon size reduces. If one of the menu icons is executed, the one of menu icon size magnifies. In addition, the reduction or the magnification of display size of the menu icons are limited to a maximum value.

### BACKGROUND

1. Technical Field

Embodiments of the present disclosure relate to a user interface of an electronic device, and more particularly to a method for varying icon sizes of the menu icons displayed in the user interface and the electronic device using the same.

2. Description of Related Art

Touch panels are utilized in many electronic devices, providing an improved input means with advantages of convenience and ease of use over typical keypad-style input. Most popular electronic devices adopt an icon menu as a user interface for operation. However, it is difficult to find a menu icon corresponding to an executable application in a menu if there are many icons displayed on the user interface. What is needed, is a system and method to overcome the limitations described.

### BRIEF DESCRIPTION OF THE DRAWINGS

FIG. 1 is a block diagram of one embodiment of an electronic device comprising a menu icon adjustment system.

FIG. 2 is a schematic diagram of a menu displayed in the user interface of FIG. 1 having menu icons with a predetermined size.

FIG. 3-FIG. 4 are schematic diagrams of the menu displayed in the user interface of FIG. 1 having menu icons with variable sizes.

FIG. 5 is a flowchart illustrating one embodiment of a method for varying icon sizes of the menu icons displayed in the user interface using an electronic device.

### DETAILED DESCRIPTION

The application is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

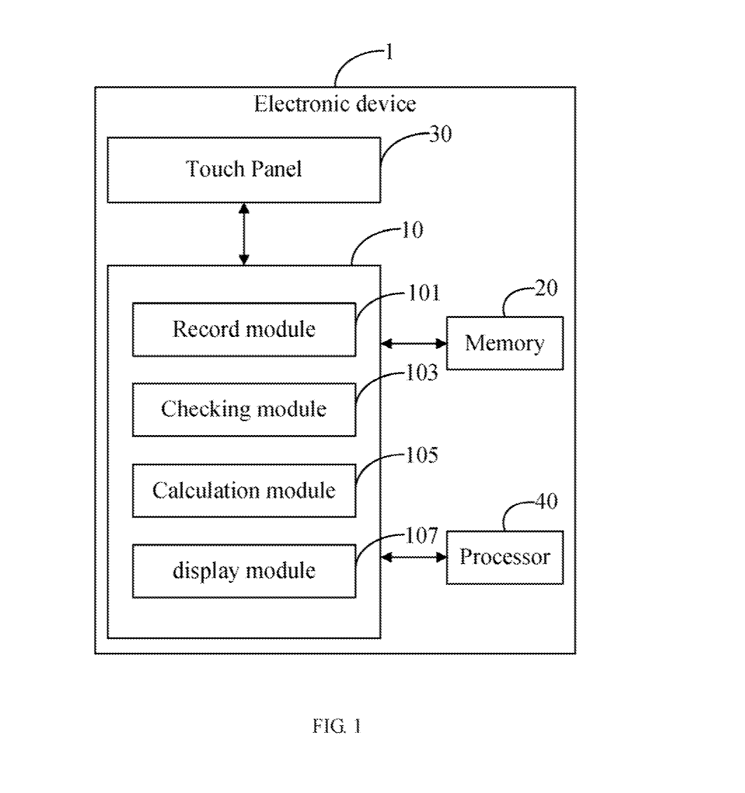

FIG. 1 is a block diagram of one embodiment of an electronic device 1 comprising a menu icon adjustment system 10. The electronic device 1 further comprises a memory 20, a touch panel 30, and at least one processor 40. The touch panel 30 is capable of displaying multiple menu icons on a user interface. Each menu icon displayed on the touch panel 30 is linked to a corresponding application stored in the memory 20. The electronic device 1 can vary icon sizes of the menu icons on the touch panel 30 using the menu icon adjustment system 10.

The electronic device 1 is generally controlled and coordinated by operating system software, such as the UNIX, Linux, Windows 95, 98, NT, 2000, XP, Vista, Mac OS X, an embedded operating system, or any other compatible operating systems. In other embodiments, the electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

The memory 20 is electronically connected to the menu icon adjustment system 10, the touch panel 30 and the at least one processor 40. The memory 20 is operable to store many kinds of data, such as a customization function code of the electronic device 1, computerized codes of the menu icon adjustment system 10, programs of an operating system and other applications of the electronic device 1. The memory 20 may include a hard disk drive, flash memory, RAM, ROM, cache, or external storage mediums.

The touch panel 30 is operable to detect at least one contact (e.g., a finger, stylus) on the touch panel 30 and generate and send at least one coordinate value of the at least one contact on the touch panel 30 to the menu icon adjustment system 10. In one embodiment, a user can contact the touch panel 30 using one or more finger contacts. For example, the touch panel 30 can detect one or more contacts in two or three locations on the touch panel 30 at the same time to generate two or three coordinate values of the one or more contacts to the menu icon adjustment system 10. In some embodiments, a stylus can be used with the touch panel 30. In addition, the touch panel 30 further displays information received from the menu icon adjustment system 10, the memory 20 and the at least one processor 40.

The at least one processor 40 is operable to execute one or more computerized codes of the menu icon adjustment system 10 may be stored in the memory 20 and executed by the at least one processor 40. The at least one processor 40, as an example, may include a CPU, math coprocessor, or shift register.

The menu icon adjustment system 10 includes a record module 101, a checking module 103, a calculation module 105 and a display module 107. The menu icon adjustment system 10 is configured to connect to the memory 20, the touch panel 30, and the processor 40. The menu icon adjustment system 10 is operable to vary icon sizes of the menu icons on the touch panel 30 of the electronic device 1.

The record module 101 is operable to save an execution time of the menu icon corresponding to the application in the memory 20. In one embodiment, when the user uses a finger or a stylus to contact the menu icon displayed in the user interface, the record module 101 saves the time as the execution time of the menu icon contacted in the memory 20. In other embodiments, the execution time of the menu icon can be in a unit of a day or in a unit of an hour.

The checking module 103 is operable to check an execution status of the menu icon corresponding to the application in the memory 20 during a time period. In one embodiment, the execution status of the menu icon indicates that the menu icon is executed. The execution status of the menu icon can be executed or not executed. The execution status of the menu icon can be determined by the execution time of the menu icon. For example, if there is a record of the execution time during the time period, the execution status of the menu icon is executed. Otherwise, there is no record of the execution time during the time period, the execution status of the menu icon is not executed.

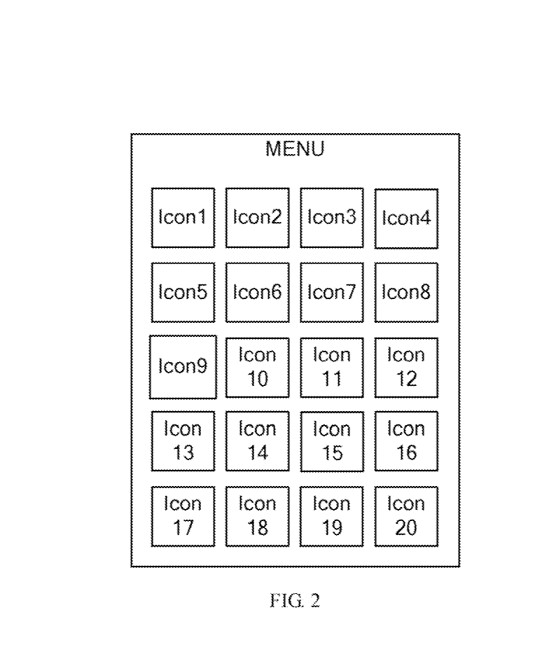

The calculation module 105 is operable to calculate a display size of the menu icon by the execution status of the menu icon. In one embodiment, the calculation module 105 calculates the display size of the menu icon when the touch panel 30 is turned on. If the time period is set in the unit of a day, the calculation module 105 calculates the display size of the menu icon at a certain time, such as 12:00 am. Each menu icon has a predetermined size displayed on the touch panel 30. As shown in FIG. 2, the predetermined size of the menu icon is preset by a visual size of the area displayed on the touch panel 30 divided by a number of the menu icon.

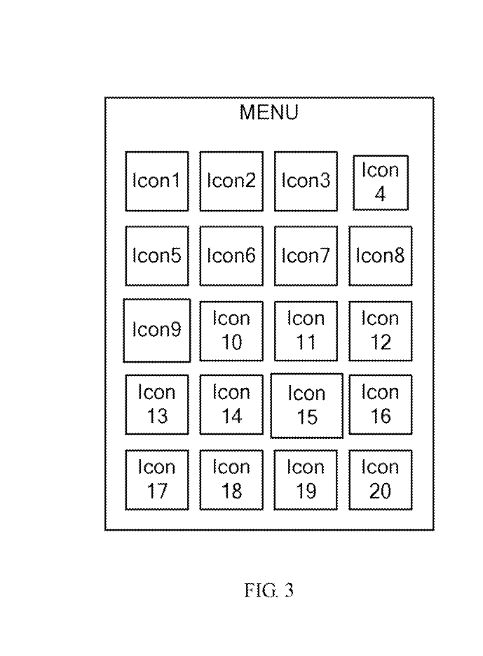

As shown in FIG. 3, if the checking module 103 determines the menu icon 15 corresponding to the application in the memory is executed on the first day. The calculation module 105 calculates the display size of the menu icon 15 which is increased by 15% on the second day than an original display size of the menu icon 15 on the first day. The display size of the menu icon 15 on the second day (Icon 15 shown in FIG. 3) becomes a 115% of the size of the display size of the menu icon 15 on the first day (Icon 15 shown in FIG. 2).

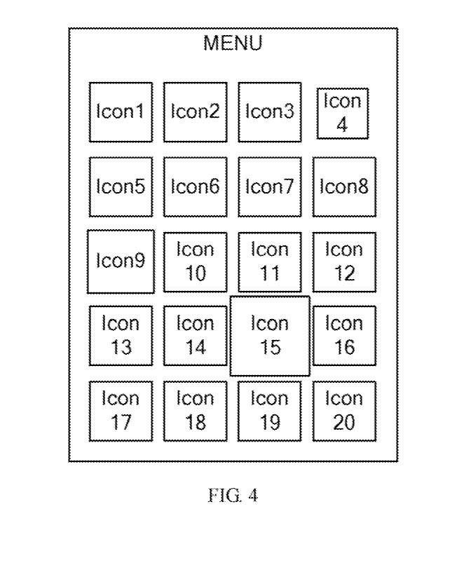

For more examples, if the menu icon 15 is continually executed on the third day. The calculation module 105 calculates the display size of the menu icon 15 which is increased by 15% on the third day (Icon 15 shown in FIG. 4) than the display size of the menu icon 15 on the second day (Icon 15 shown in FIG. 3). Accordingly, the display size of the menu icon 15 on the third day is 132% of the display size (Icon 15 shown in FIG. 4) to the display size of the first day (Icon 15 shown in FIG. 2). In addition, an amplification display size of the menu icon limits at 200%.

In other embodiments, if the checking module 103 determines the menu icon 4 corresponding to the application in the memory is not executed on the first day. The calculation module 105 calculates the display size of the menu icon 4 which is decreased by 15% on the second day (Icon 4 shown in FIG. 3) than an original display size of the menu icon 4 on the first day (Icon 4 shown in FIG. 2). The display size of the menu icon 4 on the second day (Icon 4 shown in FIG. 3) becomes 85% of the display size to the display size of the menu icon 4 on the first day (Icon 4 shown in FIG. 2).

For more examples, if the menu icon 4 is not executed on the third day. The calculation module 105 calculates the display size of the menu icon 4 which is decreased by 15% on the third day (Icon 4 shown in FIG. 4) than the display size of the menu icon 4 (Icon 4 shown in FIG. 3) on the second day. Accordingly, the display size of the menu icon 4 on the third day (Icon 4 shown in FIG. 4) is 72% of the display size to the display size of the menu icon 4 on the first day (Icon 4 shown in FIG. 2). In addition, a reduction of display size of the menu icon limits at 50%.

In other embodiments, if the time period is set in the unit of an hour, the calculation module 105 calculates the display size of the menu icon 15 on each hour, such as 1:00 am, or 2:00 am. Accordingly, if the checking module 103 determines the menu icon 15 is executed at the first hour, the calculation module 105 calculates 115% of the display size of the menu icon 15 on the second hour (Icon 15 shown in FIG. 3) to the display size of the menu icon 15 on the first hour (Icon 15 shown in FIG. 2). For other examples, if the checking module 103 determines the menu icon 4 is not executed on the first hour. The calculation module 105 calculates 85% of the display size of the menu icon 4 on the second hour (Icon 4 shown in FIG. 3) to the display size of the menu icon 4 on first hour (Icon 4 shown in FIG. 2).

The display module 107 is operable to display the icon size of the menu icon by the calculated display size of the menu icon by the calculation module 105. In one embodiment, the display module 107 displays the icon size of the menu icon each day if the time period is set to the unit of a day. In other embodiments, the display module 107 displays the icon size of the menu icon each hour if the time period is set in the unit of an hour.

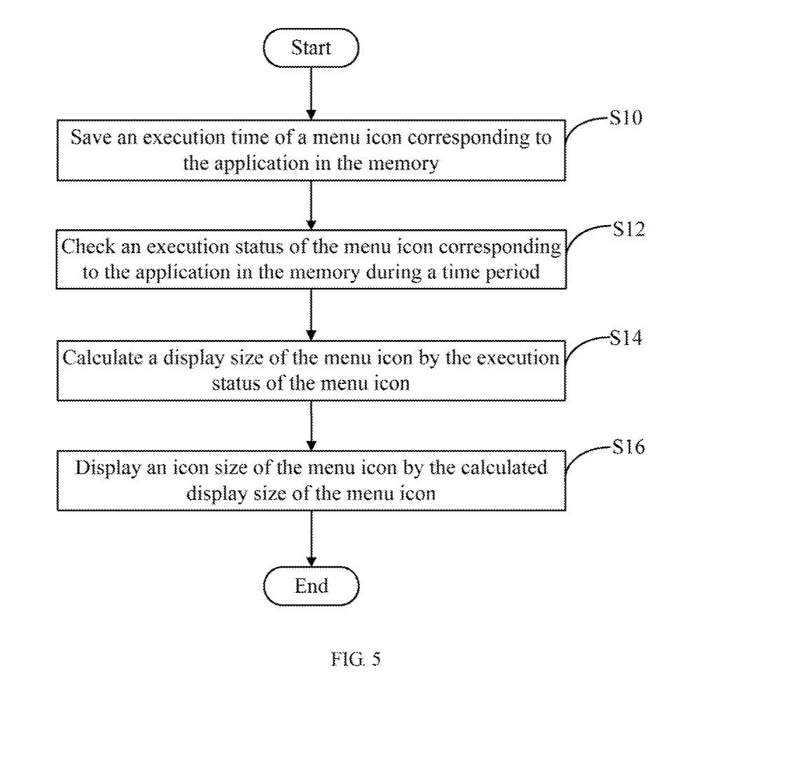

FIG. 5 is a flowchart illustrating one embodiment of a method for varying icon sizes of the menu icons displayed in the user interface using the electronic device 1. Depending on the embodiment, additional blocks may be added, others deleted, and the ordering of blocks may be changed.

In block S10, the record module 101 saves an execution time of the menu icon corresponding to the application in the memory 20. In one embodiment, when the user uses a finger or a stylus to contact the menu icon displayed in the user interface, the record module 101 saves the time as the execution time of the menu icon contacted in the memory 20. In other embodiments, the execution time of the menu icon can be in a unit of a day or in a unit of an hour.

In block S12, the checking module 103 checks an execution status of the menu icon corresponding to the application in the memory 20 during a time period. In one embodiment, the execution status of the menu icon indicates that the menu icon is executed. The execution status of the menu icon can be executed or not executed. The execution status of the menu icon can be determined by the execution time of the menu icon. For example, if there is a record of the execution time during the time period, the execution status of the menu icon is executed. Otherwise, there is no record of the execution time during the time period, the execution status of the menu icon is not executed.

In block S14, the calculation module 105 calculates a display size of the menu icon by the execution status of the menu icon contacted.

In block S16, the display module 107 displays the icon size of the menu icon by the calculated display size of the menu icon. In one embodiment, the display module 107 displays the icon size of the menu icon each day if the time period is set to the unit of a day. In other embodiments, the display module 107 displays the icon size of the menu icon each hour if the time period is set in the unit of an hour.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a memory;
a touch panel;
at least one processor;
one or more programs that are stored in the memory and are executed by the at least one processor, the one or more programs comprising:
a record module operable to save an execution time of a menu icon corresponding to an application in the memory;
a checking module operable to check an execution status of the menu icon corresponding to the application in the memory during a time period;
a calculation module operable to calculate a display icon size of the menu icon by the execution status of the menu icon; and
a display module operable to display the icon size of the menu icon on the touch panel by the calculated display size of the menu icon.

2. The electronic device as claimed in claim 1, wherein the time period is in a unit of a day or in a unit of an hour.

3. The electronic device as claimed in claim 1, wherein the execution status of the menu icon is determined by the execution time of the menu icon.

4. The electronic device as claimed in claim 1, wherein a predetermined size of the icon size of the menu icon is set by a number of the menu icon displayed on the touch panel.

5. The electronic device as claimed in claim 1, wherein the touch panel is a capacitive panel.

6. The electronic device as claimed in claim 1, wherein the touch panel is a resistive panel.

7. A method for enabling variable menu icon size displayed in a user interface using an electronic device, the electronic device comprising at least one processor, a memory storing applications and a touch panel receiving contacts, the method comprising:
saving an execution time of a menu icon corresponding to an application in the memory;
checking an execution status of the menu icon corresponding to the application in the memory during a time period;
calculating a display size of the menu icon by the execution status of the menu icon; and
displaying the icon size of the menu icon on the touch panel by the calculated display size of the menu icon.

8. The method as claimed in claim 7, wherein the time period is in a unit of a day or in a unit of an hour.

9. The method as claimed in claim 7, further comprising setting a predetermined size of the icon size of the menu icon by a number of the menu icon displayed on the touch panel.

10. The method as claimed in claim 7, wherein the icon size of the menu icon limits an amplification display size of the menu icon at 200%.

11. The method as claimed in claim 7, wherein the icon size of the menu icon limits a reduction of display size of the menu icon at 50%.

12. The method as claimed in claim 7, wherein the touch panel is a capacitive panel.

13. The method as claimed in claim 7, wherein the touch panel is a resistive panel.

14. A storage storing a set of instructions, the set of instructions capable of being executed by a processor to perform a method for enabling variable menu icon size displayed in a user interface using an electronic device, the electronic device comprising at least one processor, a memory storing applications and a touch panel receiving contacts, the method comprising:
saving an execution time of a menu icon corresponding to an application in the memory;
checking an execution status of the menu icon corresponding to the application in the memory during a time period;
calculating a display size of the menu icon by the execution status of the menu icon; and
displaying the icon size of the menu icon on the touch panel by the calculated display size of the menu icon.

15. The storage medium as claimed in claim 14, wherein the time period is in a unit of a day or in a unit of an hour.

16. The storage medium as claimed in claim 14, wherein the method further comprising setting a predetermined size of the icon size of the menu icon by a number of the menu icon displayed on the touch panel.

17. The storage medium as claimed in claim 14, wherein the icon size of the menu icon limits an amplification display size of the menu icon at 200%.

18. The storage medium as claimed in claim 14, wherein the icon size of the menu icon limits a reduction of display size of the menu icon at 50%.

19. The storage medium as claimed in claim 14, wherein the touch panel is a capacitive panel.

20. The storage medium as claimed in claim 14, wherein the touch panel is a resistive panel.
